(19) United States
(12) Patent Application Publication
(10) Pub. No.: US 2001/0030839 A1
(43) Pub. Date: Oct. 18, 2001

(54) Dual spin-valve magnetoresistive sensor

(76) Inventors: Lieping Zhong, Savage, MN (US); Jian Chen, Minnetonka, MN (US); Juan Jose Fernandez-De-Castro, Lakeville, MN (US)

Correspondence Address: Fish & Richardson P.C., Suite 2800, 45 Rockefeller Plaza, New York, NY, 10111, US

(21) Appl. No.: 09/757,500

(22) Filed: Jan. 10, 2001

Related U.S. Application Data
(60) Provisional application No. 60/176,169, filed on Jan. 13, 2000.

(51) Int. Cl. G11B 5/39

(52) U.S. Cl. 360/314

(57) ABSTRACT

A dual spin-valve magnetoresistive sensor includes a free ferromagnetic layer and first and second nonmagnetic conductive spacers adjacent to opposing first and second surfaces of the free layer, respectively. A pinned ferromagnetic layer consisting of a single-film ferromagnetic layer is adjacent to the first spacer and a laminated pinned ferromagnetic structure is adjacent to the second spacer. The laminated structure includes first and second pinned ferromagnetic films separated by a film that provides antiferromagnetic coupling. First and second antiferromagnetic layers can be provided adjacent to the pinned ferromagnetic layer and the laminated pinned structure, respectively. The sensor can be incorporated, for example, into a magnetic storage system.

### CROSS-REFERENCE TO RELATED APPLICATIONS

This application claims the benefit of priority of U.S. Provisional Patent Application No. 60/176,169, filed Jan. 13, 2000, and is a continuation of PCT application ______, filed concurrently with the present application and claiming the benefit of priority of the provisional application identified above.

### BACKGROUND

The present invention relates to dual spin-valve magnetoresistive (MR) sensors.

Magnetic read heads using MR sensors can read data from a magnetic medium at high linear densities. An MR sensor detects magnetic field signals through resistance changes in a read element as a function of the strength and direction of magnetic flux sensed by the read element.

One type of magnetoresistance is often referred to as “giant magnetoresistance” (GMR) or “spin-valve magnetoresistance.” The change in resistance of a layered magnetic sensor generally is attributed to the spin-dependent transmission of conduction electrons between magnetic layers through a nonmagnetic layer and the accompanying spin-dependent scattering at the layer interfaces.

A conventional spin-valve sensor includes a ferromagnetic layer whose magnetization is free to rotate its direction in response to an externally-applied magnetic field, a copper spacer, a ferromagnetic layer whose magnetization direction is fixed, or “pinned,” in a preferred orientation, and an antiferromagnetic film. The “free” ferromagnetic layer is designed with the magnetization oriented parallel to the sensor stripe. The “pinned” layer has a pinning field perpendicular to the sensor stripe and serves as a magnetization reference for the free layer. The two ends of the sensor are in contact with hard magnetic films that provide a horizontal stabilization field to the sensor. Electrically conducting leads are in contact with the hard magnetic film surfaces.

MR sensors having a dual spin-valve structure with an enhanced GMR effect have emerged as one of the most promising read sensors in magnetic recording applications at high linear densities. Dual spin-valve structures include a “pinned” ferromagnetic layer on both sides of the “free” ferromagnetic layer.

To achieve high linear densities, it is desirable to reduce dimensions and to improve the sensor sensitivity and stability. Various difficulties, however, have been encountered in the development of suitable dual spin-valve structures. For example, when each pinned structure consists of a single-layer ferromagnetic layer, a properly-biased free layer is difficult to obtain because large demagnetizing fields that arise from the pinned layers reinforce one another at the free layer. On the other hand, when both pinned structures comprise a multi-film laminated structure, the additional conductive layers can cause the GMR and the sheet resistance to be lower than desired, thus limiting the sensor's sensitivity.

In light of the foregoing difficulties, improvements in the design of spin-valve MR sensors are desirable.

### SUMMARY

In general, a magnetoresistive sensor includes a free ferromagnetic layer and first and second nonmagnetic conductive spacers adjacent to opposing first and second surfaces of the free layer, respectively. A pinned ferromagnetic layer consisting of a single-film ferromagnetic layer is adjacent to the first spacer and a laminated pinned ferromagnetic structure is adjacent to the second spacer. The laminated structure includes first and second pinned ferromagnetic films separated by a film that provides antiferromagnetic coupling. First and second antiferromagnetic layers can be provided adjacent to the pinned ferromagnetic layer and the laminated pinned structure, respectively.

In various implementations, one or more of the following features may be present. The pinning directions of the pinned layers can be selected to improve the sensor stability and sensitivity. In some implementations, the first antiferromagnetic layer comprises a material having a first blocking temperature and the second antiferromagnetic layer comprises a material having a second different blocking temperature. In some implementations, the first pinned ferromagnetic film in the laminated structure has a thickness greater than a thickness of the second ferromagnetic film in the laminated structure.

Exemplary materials and dimensions for the various layers are discussed in greater detail below.

The sensor can be included, for example, as part of magnetic storage and recording systems.

Possible advantages of the sensor design include improved sensitivity and stability.

Other features and advantages will be readily apparent from the following description, the accompanying drawings and the claims.

### BRIEF DESCRIPTION OF THE DRAWINGS

FIG. 1 is a top view of the interior of an exemplary disk drive assembly.

FIG. 2 illustrates a sectional view of an MR sensor.

FIG. 3 is an exploded view of the MR sensor.

### DETAILED DESCRIPTION

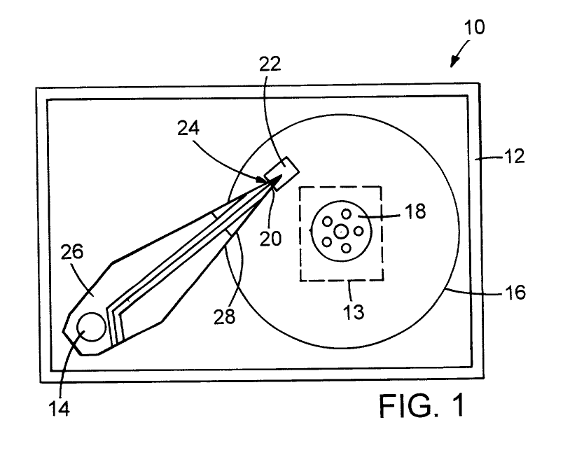

As shown in FIG. 1, an exemplary disk drive assembly 10 includes a base 12 to which a disk drive motor 13 and an actuator 14 are secured. The base 12 and a cover (not shown) provide a sealed housing for the disk drive 10. A magnetic recording disk 16 is connected to the drive motor through a hub 18 to cause rotation of the disk. Information can be stored on the disk 16, for example, along an annular pattern of concentric tracks (not shown).

A transducer 20, sometimes referred to as a read/write head, is formed on the trailing end of an air-bearing slider 22. The transducer 20 includes a magnetoresistive (MR) sensor 24 described in greater detail below. The slider 22 is connected to the actuator 14 by a rigid arm 26 and a suspension 28. The suspension 28 provides a biasing force that urges the slider 22 onto the surface of the recording disk 16.

During operation of the disk drive 10, the drive motor 13 rotates the disk 16 at a substantially constant speed. The rotation of the disk 16 generates an air bearing between the slider 22 and the disk surface that exerts an upward force on the slider. The air bearing counterbalances the slight spring force of the suspension 28 and supports the slider 22 somewhat above the disk surface by a small substantially constant spacing. During operation, the actuator 14 moves the slider 22 radially across the surface of the disk so that the transducer 20 can access different data tracks on the disk. Data detected by the transducer 20 can be processed by signal amplification and processing circuitry.

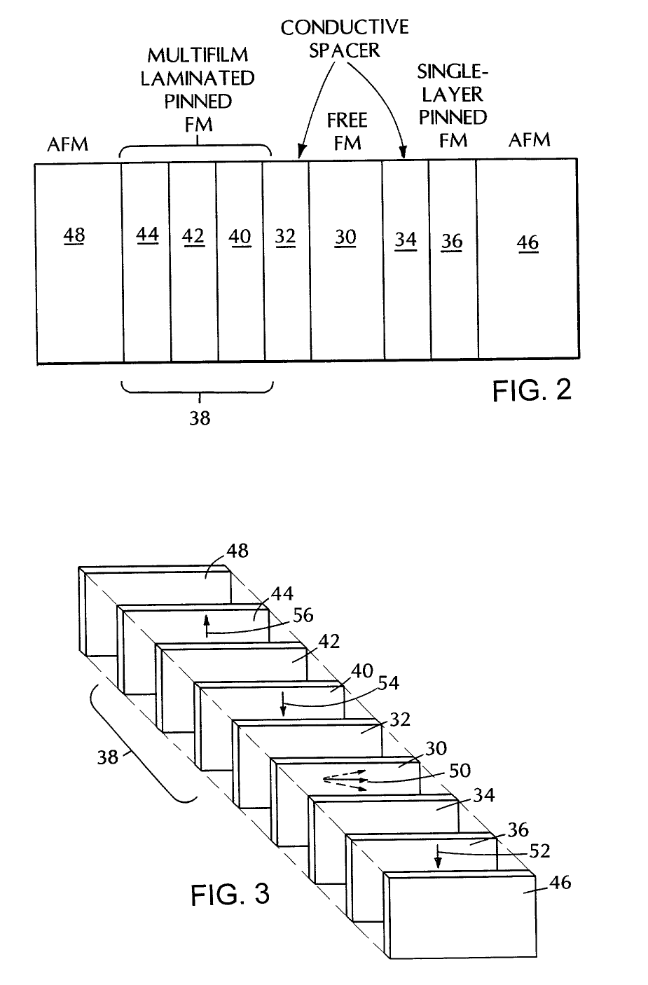

As shown in FIGS. 2 and 3, the MR sensor 24 includes a free ferromagnetic (FM) layer 30 spaced from two outer pinned layers 36, 38 by non-magnetic conductive spacers 32, 34. One pinned layer 36 consists of a single-film ferromagnetic layer. The second pinned layer 38 is a multifilm, laminated pinned structure and includes at least two ferromagnetic films 40, 44 separated by a film 42 that provides antiferromagnetic coupling. In particular, the first ferromagnetic film 40 is formed directly on the conductive spacer 32, the coupling film 42 is formed directly on the first film 40, and the second ferromagnetic film 44 is formed directly on the coupling film 42. The pinned outer ferromagnetic layers 36, 44 can be exchange biased by adjacent antiferromagnetic (AFM) layers 46, 48. To limit interference signals, the read head can be placed inside shields (not shown) that include a soft magnetic material. Insulating dielectric films (not shown) can be placed between the read head and the shields.

In the absence of an externally-applied magnetic field, the direction of magnetization of the free layer 30 is indicated by the arrow 50 in FIG. 3. The magnetization of the ferromagnetic layer 30 is free to rotate its direction in response to an externally-applied magnetic field.

The direction of magnetization of the pinned single-film ferromagnetic layer 36 is indicated by the arrow 52. Similarly, the directions of magnetization of the pinned ferromagnetic films 40, 44 in the laminated layer 38 are indicated, respectively, by the arrows 54, 56. Therefore, the magnetic moments of the pinned layers 36, 38 are perpendicular to the magnetic moment of the free layer 30 in its quiescent state.

The magnetic moments of the pinned ferromagnetic layers 36, 44 adjacent the AFM layers 46, 48 should be in opposite directions. That can be achieved, for example, by making the ferromagnetic film 40 in the laminated structure 38 thicker than the ferromagnetic film 44 so that the net moment of the laminated structure is oriented in the same direction as the single-film pinned ferromagnetic layer 36. During a subsequent annealing process, the exchange coupling between the ferromagnetic films 40, 44 in the laminated structure 38 can be used in conjunction with an applied field to fix the magnetization of the pinned layers as shown in FIG. 3. Alternatively, two AFM materials with different blocking temperatures, such as iridium-manganese (IrMn) and platinum-manganese (PtMn), can be used. After annealing, the unidirectional anisotropy of the AFM with the lower blocking temperature can be reset along the desired direction by applying a field at a temperature slightly above its setting temperature. In other words, the pinning field directions of the pinned layers can be set independently.

Exemplary materials and thicknesses for the various layers are listed below. The ferromagnetic layers 30, 36, 40, 44 can include nickel (Ni), iron (Fe), cobalt (Co) or their alloys such as nickel-iron (NiFe) and iron-cobalt (FeCo), with thicknesses in the range of 10-50 angstroms (A). The nonmagnetic metallic layers 32, 34 can include copper (Cu) or other noble metals or their alloys with a thickness of about 10-40 Å. The nonferromagnetic coupling film 42 that separates the ferromagnetic films 40, 44 in the laminated structure 38 can include a transition element such as ruthenium (Ru) or rhodium (Rh) with a thickness of about 6-15 Å. The AFM layers 46, 48 can include iron-manganese (FeMn), nickel-manganese (NiMn), IrMn or PtMn with a thickness of about 30-400 Å. Other materials and dimensions may be appropriate in various implementations.

The MR sensor 24 also can include a high resistivity capping layer (not shown). Electrical leads can be provided to form a circuit between the MR sensor 24 and a current source and sensor so that a change in resistance of the MR sensor can be sensed as the magnetization of the free ferromagnetic layer 30 rotates in response to an applied magnetic signal from the magnetic medium 16.

The flux closure in the laminated pinned structure 38 can reduce the effect of its stray field acting in the free layer 30. The field from the bias current, which flows in the same direction as the magnetic moment in the free layer 30 in its quiescent state, can help counterbalance the stray field from the single-film pinned ferromagnetic layer 36. Furthermore, the bias current fields on both sides of the free layer 30 are in the same direction as the pinning fields. Therefore, the bias current fields can assist pinning the layers 36, 44, thereby improving the stability of the sensor. Horizontal stabilization of the free layer 30 can be achieved by providing permanent magnet junctions (not shown) at the ends of the free layer.

The sensor structure described above can improve the GMR and ΔR, where ΔR represents the change in resistance in response to an external field. Simulations based on band structures of an exemplary sensor with the foregoing structure indicate a GMR of 17%. In comparison, a similar spin-valve stack with laminated pinned ferromagnetic layers on both sides of the free layer indicates a GMR of 15%. Furthermore, using only one set of laminated layers can reduce shunting of the current and can increase the sheet resistance by as much as 10%. The increase in sheet resistance and the larger GMR can result in as much as a 20% enhancement in ΔR compared to previous designs.

The MR sensor can be incorporated into various other types of magnetic storage systems including magnetic tape recording systems as well as magnetic random access memory systems in which a magnetoresistive element serves as a bit cell.

Other implementations are within the scope of the claims.

What is claimed is:

1. A magnetoresistive sensor comprising:
a free ferromagnetic layer;
first and second nonmagnetic conductive spacers adjacent to opposing first and second surfaces of the free layer, respectively;
a pinned ferromagnetic layer consisting of a single-film ferromagnetic layer adjacent to the first spacer;
a laminated pinned ferromagnetic structure adjacent to the second spacer, wherein the laminated structure includes first and second pinned ferromagnetic films separated by a film that provides antiferromagnetic coupling; and
first and second antiferromagnetic layers adjacent to the pinned ferromagnetic layer and the laminated pinned structure, respectively.

2. The magnetoresistive sensor of claim 1 wherein the second pinned ferromagnetic film in the laminated structure is adjacent to the second antiferromagnetic layer and has a direction of magnetization generally opposite to a direction of magnetization of the pinned ferromagnetic layer, and wherein the second pinned ferromagnetic film and the pinned ferromagnetic layer have directions of magnetization generally perpendicular to a direction of magnetization of the free ferromagnetic layer in the absence of an applied magnetic field.

3. The magnetoresistive sensor of claim 2 wherein the first pinned ferromagnetic film in the laminated structure has a direction of magnetization generally parallel to the direction of magnetization of the pinned ferromagnetic layer.

4. The magnetoresistive sensor of claim 3 wherein the first antiferromagnetic layer comprises a material having a first blocking temperature and the second antiferromagnetic layer comprises a material having a second different blocking temperature.

5. The magnetoresistive sensor of claim 3 wherein the first pinned ferromagnetic film in the laminated structure has a thickness greater than a thickness of the second ferromagnetic film in the laminated structure.

6. The magnetoresistive sensor of claim 3 wherein the free and pinned ferromagnetic layers and the first and second pinned ferromagnetic films comprise a material selected from a group consisting of nickel, iron and cobalt, and wherein the antiferromagnetically coupling film in the laminated structure comprises a material selected from a group consisting of ruthenium and rhodium.

7. A magnetoresistive sensor comprising:
a free ferromagnetic layer;
first and second nonmagnetic conductive spacers adjacent to opposing first and second surfaces of the free layer, respectively;
a pinned ferromagnetic layer consisting of a single-film ferromagnetic layer adjacent to the first spacer;
a laminated pinned ferromagnetic structure adjacent to the second spacer, wherein the laminated structure includes first and second pinned ferromagnetic films separated by a film that provides antiferromagnetic coupling, wherein the first pinned ferromagnetic film is adjacent to the second conductive spacer; and
means for maintaining a direction of magnetization of the second pinned ferromagnetic film in the laminated structure generally opposite a direction of magnetization of the pinned ferromagnetic layer, and means for maintaining directions of magnetization of the second pinned ferromagnetic film and the pinned ferromagnetic layer generally perpendicular to a direction of magnetization of the free ferromagnetic layer in the absence of an applied magnetic field.

8. The sensor of claim 7 including means for maintaining a direction of magnetization of the first pinned ferromagnetic film in the laminated structure generally parallel to the direction of magnetization of the pinned ferromagnetic layer.

9. A magnetic storage system comprising:
a magnetic storage medium;
a motor for causing rotation of the magnetic storage medium;
a dual spin-valve magnetoresistive sensor for sensing magnetically-recorded information on the magnetic storage medium, wherein the sensor includes:
(a) a free ferromagnetic layer;
(b) first and second nonmagnetic conductive spacers adjacent to opposing first and second surfaces of the free layer, respectively;
(c) a pinned ferromagnetic layer consisting of a single-film ferromagnetic layer adjacent to the first spacer;
(d) a laminated pinned ferromagnetic structure adjacent to the second spacer, wherein the laminated structure includes first and second pinned ferromagnetic films separated by a film that provides antiferromagnetic coupling; and
(e) first and second antiferromagnetic layers adjacent to the pinned ferromagnetic layer and the laminated pinned structure, respectively; and
an actuator for causing movement of the sensor across the magnetic storage medium so that the sensor can access different regions of magnetically-recorded data on the storage medium.

10. The system of claim 9 wherein the second pinned ferromagnetic film in the laminated structure is adjacent to the second antiferromagnetic layer and has a direction of magnetization generally opposite to a direction of magnetization of the pinned ferromagnetic layer, and wherein the second pinned ferromagnetic film and the pinned ferromagnetic layer have directions of magnetization generally perpendicular to a direction of magnetization of the free ferromagnetic layer in the absence of an applied magnetic field.

11. The system of claim 10 wherein the first pinned ferromagnetic film in the laminated structure has a direction of magnetization generally parallel to the direction of magnetization of the pinned ferromagnetic layer.

12. The system of claim 11 wherein the first antiferromagnetic layer comprises a material having a first blocking temperature and the second antiferromagnetic layer comprises a material having a second different blocking temperature.

13. The system of claim 11 wherein the first pinned ferromagnetic film in the laminated structure has a thickness greater than a thickness of the second ferromagnetic film in the laminated structure.

14. The system of claim 11 wherein the free and pinned ferromagnetic layers and the first and second pinned ferromagnetic films comprise a material selected from a group consisting of nickel, iron and cobalt, and wherein the antiferromagnetic coupling film in the laminated structure comprises a material selected from a group consisting of ruthenium and rhodium.

15. A magnetic storage system comprising:
a magnetic storage medium;
a transducer maintained close to the magnetic storage medium during relative motion between the transducer and the storage medium, wherein the transducer includes a magnetoresistive sensor for sensing magnetically-recorded information on the magnetic storage medium, and wherein the sensor includes:
(a) a free ferromagnetic layer;
(b) first and second nonmagnetic conductive spacers adjacent to opposing first and second surfaces of the free layer, respectively;
(c) a pinned ferromagnetic layer consisting of a single-film ferromagnetic layer adjacent to the first spacer; and
(d) a laminated pinned ferromagnetic structure adjacent to the second spacer, wherein the laminated structure includes first and second pinned ferromagnetic films separated by a film that provides antiferromagnetic coupling.

16. The system of claim 15 wherein the sensor includes first and second antiferromagnetic layers adjacent to the pinned ferromagnetic layer and the laminated pinned structure, respectively.

17. The system of claim 16 wherein the first antiferromagnetic layer comprises a material having a first blocking temperature and the second antiferromagnetic layer comprises a material having a second different blocking temperature.

18. The system of claim 16 wherein the first pinned ferromagnetic film in the laminated structure has a thickness greater than a thickness of the second ferromagnetic film in the laminated structure.

19. The system of claim 15 wherein the first pinned ferromagnetic film in the laminated structure is adjacent to the second conductive spacer, and wherein the sensor includes means for maintaining a direction of magnetization of the second pinned ferromagnetic film in the laminated structure generally opposite to a direction of magnetization of the pinned ferromagnetic layer, means for maintaining directions of magnetization of the second pinned ferromagnetic film and the pinned ferromagnetic layer generally perpendicular to a direction of magnetization of the free ferromagnetic layer in the absence of an applied magnetic field, and means for maintaining a direction of magnetization of the first pinned ferromagnetic film in the laminated structure generally parallel to the direction of magnetization of the pinned ferromagnetic layer.

20. A magnetoresistive sensor comprising a dual spin-valve stack having a free ferromagnetic layer and means for increasing the GMR and sheet resistance of the sensor.
